(19) United States
(12) Patent Application Publication
(10) Pub. No.: US 2021/0049364 A1
(43) Pub. Date: Feb. 18, 2021

(54) Method, Device And System For Monitoring Ride-Hailing Vehicle

(71) Applicant: BOE TECHNOLOGY GROUP CO., LTD., Chaoyang, Beijing (CN)

(72) Inventors: Xinan Wang, Beijing (CN); Qian Zhang, Beijing (CN)

(21) Appl. No.: 16/978,788

(22) PCT Filed: Dec. 20, 2019
(86) PCT No.: PCT/CN2019/127049

§ 371 Date: Sep. 8, 2020

(30) Foreign Application Priority Data
Jan. 2, 2019 (CN) 201910001379.0

(51) Int. Cl. G06K 9/00; G06Q 10/02; B60N 2/00; G06Q 50/30

(52) U.S. Cl. CPC G06K 9/00711; G06K 9/00791; G06Q 50/30; G06Q 10/02; B60N 2/002; G06K 9/00838

(57) ABSTRACT

A method, a device and a system for monitoring a ride-hailing vehicle are disclosed. An embodiment of the method comprises: transmitting a service request to a ride-hailing service center in response to a triggering condition; and obtaining, by the ride-hailing service center, according to the service request, an image inside and/or outside a vehicle collected by a vehicle terminal, and distributing the image inside and/or outside the vehicle.

### TECHNICAL FIELD

The disclosure relates to a method, a device and a system for monitoring a ride-hailing vehicle.

### BACKGROUND

The existing ride-hailing vehicle is popular among passengers due to its convenience, efficiency and low price. While the ride-hailing vehicle provides convenient and efficient services for the passenger during traveling, it also exposes that the hidden danger in personal and property safety is brought to the passenger due to the fact that related departments cannot effectively supervise the ride-hailing vehicle.

The existing dashboard camera records audio and video information outside the vehicle and sound information inside the vehicle, and its microphone inside the vehicle is controlled by a driver and it cannot be controlled by the passenger through the ride-hailing service center so as to realize monitoring and recording of a riding process. Therefore, safety factors cannot be increased, and contents of the records of the monitoring cannot be used as evidences after an event occurs.

### SUMMARY

An object of the disclosure is to provide a method, a device and a system for monitoring a ride-hailing vehicle.

In order to achieve the above object, the following technical solutions are adopted in the disclosure:

A first aspect of the disclosure provides a method for monitoring a ride-hailing vehicle, comprising:

transmitting a service request to a ride-hailing service center in response to a triggering condition, so that the ride-hailing service center obtains an image inside and/or outside a vehicle collected by a vehicle terminal and distributes the image inside and/or outside the vehicle.

According to the method for monitoring the ride-hailing vehicle provided by the first aspect of the disclosure, the ride-hailing service center obtains, according to a service request, the image inside and/or outside the vehicle collected by the vehicle terminal, and distributes them, so that it is possible to implement that the monitoring of the ride-hailing vehicle can be initiated by the passenger through the ride-hailing service center or the monitoring of the ride-hailing vehicle can be automatically initiated according to a preset triggering condition, which is beneficial for the monitoring of the ride-hailing vehicle by the ride-hailing service center, increases the safety factor of the passenger when taking the ride-hailing vehicle, and the uploaded information (i.e., the records of the monitoring) can be used as evidences after the event such as conflict, personal injury or the like occurs.

According to some embodiments of the disclosure, the triggering condition comprises one of:

sensing a triggering action from a passenger;

sensing that a current position deviates from a preset route; and

sensing the passenger entering into a vehicle.

By adopting the above embodiment, it is possible to implement, by sensing the triggering action from the passenger, that the monitoring of the ride-hailing vehicle can be initiated by the passenger through the ride-hailing service center, and to implement, by sensing the triggering condition that the current position deviates from the preset route or the passenger enters the vehicle, that the monitoring of the ride-hailing vehicle can be automatically initiated by the ride-hailing service center.

According to some embodiments of the disclosure, if the triggering condition is the sensing of the entering of the passenger into the vehicle, the method further comprises:

informing the passenger whether the service request is permitted to be transmitted to the ride-hailing service center. For example, the passenger may be notified via a mobile terminal of the passenger, or may be notified via a device such as a display screen, a speaker or the like of the vehicle terminal.

According to some embodiments of the disclosure, the obtaining of the image inside and/or outside the vehicle collected by the vehicle terminal further comprises: obtaining an image of a key frame outside the vehicle collected by the vehicle terminal, wherein the key frame is an image frame containing a landmark building during a trip.

By adopting the above embodiment, data transmission quantity of the image uploaded to the ride-hailing service center can be saved, thereby ensuring the image is uploaded in time.

According to some embodiments of the disclosure, the method further comprises: transmitting the service request to the ride-hailing service center in response to the triggering condition, so that the ride-hailing service center obtains a sound inside and/or outside the vehicle collected by the vehicle terminal, and distributes the sound inside and/or outside the vehicle.

By adopting the above embodiment, an integrity of the records of the monitoring can be improved.

A second aspect of the disclosure provides a method for monitoring a ride-hailing vehicle, comprising:

obtaining, by an ride-hailing service center, according to a service request, an image inside and/or outside a vehicle collected by a vehicle terminal, and distributing the image inside and/or outside the vehicle, wherein the service request is transmitted to the ride-hailing service center in response to a triggering condition.

According to the method for monitoring the ride-hailing vehicle provided by the second aspect of the disclosure, the ride-hailing service center obtains, according to a service request, the image inside and/or outside the vehicle collected by the vehicle terminal, and distributes them, so that it is possible to implement that the monitoring of the ride-hailing vehicle can be initiated by the passenger through the ride-hailing service center or the monitoring of the ride-hailing vehicle can be automatically initiated according to a preset triggering condition, which is beneficial for the monitoring of the ride-hailing vehicle by the ride-hailing service center, increases the safety factor of the passenger when taking the ride-hailing vehicle, and the uploaded information (i.e., the records of the monitoring) can be used as evidences after the event such as conflict , personal injury or the like occurs.

According to some embodiments of the disclosure, the distributing of the image inside and/or outside the vehicle further comprises:

distributing the image inside and/or outside the vehicle according to a preset condition, wherein the preset condition comprise at least one of:

distributing to a mobile terminal of a passenger;

distributing to a third-party receiving terminal; and

storing locally at the ride-hailing service center and distributing a service address to a client of the passenger or the third-party receiving terminal.

By adopting the above embodiment, the ride-hailing service center can select, according to the preset condition, a party that implements the monitoring. For example, the ride-hailing service center can implement multiple processing manners on the obtained image, wherein the image can be stored locally at the ride-hailing service center and processed by the ride-hailing service center; or the image can be transmitted to the mobile terminal of the passenger or the mobile terminal of a family member or a contact person specified by the passenger; or the image can be transmitted directly to a traffic management bureau platform, or the like.

According to some embodiments of the disclosure, the preset condition is set by a mobile terminal of the passenger. By adopting the above embodiment, the passenger can autonomously select, through the mobile terminal, one or more preset conditions for image distribution.

According to some embodiments of the disclosure, the method further comprises: obtaining, by the ride-hailing service center, according to the service request, a sound inside and/or outside the vehicle collected by the vehicle terminal, and distributing the sound inside and/or outside the vehicle.

By adopting the above embodiment, an integrity of the records of the monitoring can be improved. For example, the sound inside and/or outside the vehicle may be distributed in a manner similar to the distributing of the image according to a preset condition.

According to some embodiments of the disclosure, the method further comprises:

receiving, by the ride-hailing service center, ride-hailing operation information transmitted by a mobile terminal of the passenger or a ride-hailing agent.

By adopting the above embodiment, the ride-hailing operation can be implemented by the passenger at the mobile terminal of the passenger or can also be implemented by the ride-hailing agent at the mobile terminal of the ride-hailing agent. In a case where the ride-hailing operation is performed by the ride-hailing agent at the mobile terminal of the ride-hailing agent, the mobile terminal of the ride-hailing agent may serve as a receiving terminal for the image distribution.

According to some embodiments of the present disclosure, if the ride-hailing service center receives the ride-hailing operation information transmitted by the mobile terminal of the ride-hailing agent:

transmitting a distribution request to the mobile terminal of the passenger, wherein the distribution request is about whether the ride-hailing service center is permitted to distribute the image inside and/or outside the vehicle to the mobile terminal of the ride-hailing agent.

By adopting the above embodiment, if the ride-hailing agent carries out the ride-hailing operation, the passenger can select whether the mobile terminal of the ride-hailing agent is used as the receiving terminal for the image distribution.

A third aspect of the present disclosure provides a device for monitoring a ride-hailing vehicle, comprising:

a processor configured to transmit a service request to a ride-hailing service center in response to a trigger condition, so that the ride-hailing service center obtains an image inside and/or outside the vehicle collected by a vehicle terminal, and distribute the image inside and/or outside the vehicle.

According to the device for monitoring the ride-hailing vehicle provided by the third aspect of the disclosure, the ride-hailing service center obtains, according to a service request, the image inside and/or outside the vehicle collected by the vehicle terminal, and distributes them, so that it is possible to implement that the monitoring of the ride-hailing vehicle can be initiated by the passenger through the ride-hailing service center or the monitoring of the ride-hailing vehicle can be automatically initiated according to a preset triggering condition, which is beneficial for the monitoring of the ride-hailing vehicle by the ride-hailing service center, increases the safety factor of the passenger when taking the ride-hailing vehicle, and the uploaded information (i.e., the records of the monitoring) can be used as evidences after the event such as conflict, personal injury or the like occurs.

According to some embodiments of the disclosure, the device further comprises:

a vehicle-mounted trigger switch and/or a trigger arranged in the mobile terminal of the passenger, respectively configured to receive a triggering action of the passenger.

By adopting the above embodiment, it is possible to implement that the passenger can trigger the transmitting of the service request through the triggering action by the mobile terminal or the vehicle-mounted service request button, implementing that the monitoring of the ride-hailing vehicle can be initiated by the passenger through the ride-hailing service center.

According to some embodiments of the disclosure, wherein the processor is further configured to:

acquire a current position of the vehicle;

determine whether the current position deviates from a preset route, and if so, instruct to transmit the service request.

By adopting the above embodiment, it is possible to implement, by determining whether the current position deviates from the preset route, that the monitoring of the ride-hailing vehicle can be automatically initiated by the ride-hailing service center.

According to some embodiments of the disclosure, the device further comprises:

a pressure sensor configured to sense whether a passenger sits within the vehicle;

wherein the processor is further configured to: instruct to transmit the service request if the pressure sensor senses that the passenger sits within the vehicle.

By adopting the above embodiment, it is possible to implement, by sensing the triggering condition that the passenger enters the vehicle, that the monitoring of the ride-hailing vehicle can be automatically initiated by the ride-hailing service center.

A fourth aspect of the present disclosure provides a system for monitoring a ride-hailing vehicle, comprising: a device for monitoring the ride-hailing vehicle, a vehicle terminal and a ride-hailing service center;

wherein the device for monitoring the ride-hailing vehicle is configured to transmit a service request to the ride-hailing service center in response to a triggering condition; and

wherein the ride-hailing vehicle service center is configured to obtain, according to the service request, an image inside and/or outside the vehicle collected by the vehicle terminal, and distribute the image inside and/or outside the vehicle.

According to the system for monitoring the ride-hailing vehicle provided by the fourth aspect of the disclosure, the ride-hailing service center obtains, according to a service request, the image inside and/or outside the vehicle collected by the vehicle terminal, and distributes them, so that it is possible to implement that the monitoring of the ride-hailing vehicle can be initiated by the passenger through the ride-hailing service center or the monitoring of the ride-hailing vehicle can be automatically initiated according to a preset triggering condition, which is beneficial for the monitoring of the ride-hailing vehicle by the ride-hailing service center, increases the safety factor of the passenger when taking the ride-hailing vehicle, and the uploaded information (i.e., the records of the monitoring) can be used as evidences after the event such as conflict, personal injury or the like occurs.

### BREIF DESCRIPTION OF THE DRAWINGS

The following detailed description of the embodiments of the disclosure is provided in combination with the accompanying drawings:

FIG. 1A shows a flowchart of a method for monitoring a ride-hailing vehicle provided by the embodiments of the disclosure.

FIG. 1B shows a block diagram of a device for monitoring a ride-hailing vehicle provided by the embodiments of the disclosure.

FIG. 2 shows a swim lane diagram of the method for monitoring the ride-hailing vehicle.

FIG. 3 shows another swim lane diagram of the method for monitoring the ride-hailing vehicle.

FIG. 4 shows another swim lane diagram of the method for monitoring the ride-hailing vehicle.

FIG. 5 shows another swim lane diagram of the method for monitoring the ride-hailing vehicle.

FIG. 6 shows a schematic structural diagram of a server of a ride-hailing service center provided by the embodiments of the disclosure.

### DETAILED DESCRIPTION

To more clearly illustrate the disclosure, the disclosure is further described below in combination with the preferred embodiments and the accompanying drawings. Similar components in the figures are denoted by the same reference numerals. It is to be understood by those skilled in the art that the following detailed description is illustrative rather than restrictive and should not limit the scope of the present disclosure.

Therefore, it is necessary to provide a method, a device and a system for monitoring a ride-hailing vehicle, which can implement the records of the monitoring of the riding process controlled by the ride-hailing service center.

According to the technical solution of the disclosure, it is possible to implement that the monitoring of the ride-hailing vehicle can be initiated by the passenger through the ride-hailing service center or the monitoring of the ride-hailing vehicle can be automatically initiated according to a preset triggering condition, and furthermore, the party that implements the monitoring can be selected according to the preset condition. This is beneficial for the monitoring of the ride-hailing vehicle by the ride-hailing service center, increases the safety factor of the passenger when taking the ride-hailing vehicle, and the uploaded information (i.e., the records of the monitoring) can be used as evidences after the event such as conflict, personal injury or the like occurs.

Some embodiments of the disclosure provide a method for monitoring a ride-hailing vehicle. It is understandable that the method for monitoring the ride-hailing vehicle is also applicable to various scenarios such as the monitoring of a taxi.

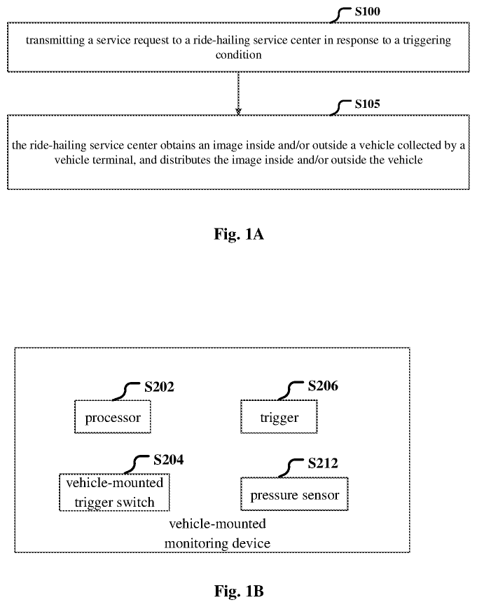

As shown in FIG. 1A, the method for monitoring the ride-hailing vehicle provided by the embodiment comprises:

S100: transmitting a service request to a ride-hailing service center in response to a triggering condition;

S105: obtaining, by the ride-hailing service center, according to the service request, an image inside and/or outside the vehicle collected by a vehicle terminal, and distributing the image inside and/or outside the vehicle.

For example, one or more of communication manners such as GPS communication, Beidou communication, 4G/5G communication and the like may be adopted between the ride-hailing service center and the vehicle terminal. For example, at least a GPS/Beidou dual-mode communication manner is adopted, so that communication can also be performed in an environment where a mobile communication network is unstable.

According to the method for monitoring the ride-hailing vehicle provided by the embodiment, the ride-hailing service center initiates, according to a service request, collecting and uploading of the image inside and/or outside the vehicle, and distributes them according to a preset condition, so that it is possible to implement that the monitoring of the ride-hailing vehicle can be initiated by the passenger through the ride-hailing service center or the monitoring of the ride-hailing vehicle can be automatically initiated according to a preset triggering condition, which is beneficial for the monitoring of the ride-hailing vehicle by the ride-hailing service center, increases the safety factor of the passenger when taking the ride-hailing vehicle, and the uploaded information (i.e., the records of the monitoring) can be used as evidences after the event such as conflict, personal injury or the like occurs.

In some exemplary implementations of the embodiment, the method further comprises:

initiating, by the ride-hailing service center, according to the service request, collecting of the image inside and/or outside the vehicle by the vehicle terminal, obtaining the image inside and/or outside the vehicle, and distributing the collected image inside and/or outside the vehicle.

By adopting the implementation manner, it is possible to implement that the collecting function of the vehicle terminal can be initiated by the passenger through the ride-hailing service center or the collecting function of the vehicle terminal can be automatically initiated according to the preset triggering condition, thereby avoiding the case that the ride-hailing service center cannot successfully obtain the image inside and/or outside the vehicle due to the fact that the collecting function of the vehicle terminal is turned off.

In some exemplary implementations of the embodiment, the triggering condition includes one of:

sensing a triggering action from a passenger;

sensing that the current position deviates from a preset route;

sensing the passenger entering into the vehicle.

For example, the triggering action of the passenger may be a triggering action of the passenger through a mobile terminal or a vehicle-mounted trigger switch. The sensing of the passenger entering into the vehicle can be implemented by carrying out an image recognition on the collected image in the vehicle or by arranging a pressure sensing circuit at a seat. By adopting the implementation, it is possible to implement, by sensing the triggering action from the passenger, that the monitoring of the ride-hailing vehicle can be initiated by the passenger through the ride-hailing service center, and it is possible to implement, by sensing the triggering condition that the current position deviates from the preset route or the passenger enters into the vehicle, that the monitoring of the ride-hailing vehicle can be automatically initiated by the ride-hailing service center.

In some exemplary implementations of the embodiment, the distributing of the image inside and/or outside the vehicle further comprises:

distributing the image inside and/or outside the vehicle according to a preset condition, wherein the preset condition comprises at least one of:

distributing to a mobile terminal of the passenger;

distributing to a third-party receiving terminal; and

storing locally in the ride-hailing service center, and distributing a service address to a client of the passenger or the third-party receiving terminal.

By adopting the implementation, the ride-hailing service center can select, according to the preset condition, a party that implements the monitoring, and can realize various processing manners of the obtained image. For example, the image can be locally stored at the ride-hailing service center and processed by the ride-hailing service center; or the image can be transmitted to a mobile terminal of the passenger or a mobile terminal of a family member or a contact person specified by the passenger; or the image can be transmitted directly to a traffic management bureau platform, or the like.

In some exemplary implementations of the embodiment, the preset condition is set by a mobile terminal of the passenger. By adopting the implementation, the passenger can autonomously select, through the mobile terminal, one or more of the preset conditions for image distribution.

In some exemplary implementations of the embodiment, the method further comprises:

receiving, by the ride-hailing service center, ride-hailing operation information transmitted by the mobile terminal of the passenger or a ride-hailing agent.

By adopting the implementation, the ride-hailing operation can be implemented by the passenger at the mobile terminal of the passenger or can also be implemented by the ride-hailing agent at the mobile terminal of the ride-hailing agent. In the case where the ride-hailing operation is performed by the ride-hailing agent at the mobile terminal of the ride-hailing agent, the mobile terminal of the ride-hailing agent may serve as a receiving terminal for the image distribution. For example, by taking, as an example, that the ride-hailing operation can be implemented by the passenger at the mobile terminal of the passenger, the passenger performs operations such as registering at the ride-hailing service center, placing an order, or the like through an APP or a webpage client of the mobile terminal of the passenger before the passenger takes the ride-hailing vehicle, and the vehicle terminal of the ride-hailing vehicle (comprising a vehicle-mounted collecting device and the like) is registered and bound at the ride-hailing vehicle management platform (a server of the ride-hailing service center performs the binding of a license plate number, a driver's license, a driving license, a vehicle identification number with the vehicle terminal in a manner of registration in advance, and enables a role and function of a ride-hailing driver). Therefore, the ride-hailing service center can associate the mobile terminal of the passenger with the vehicle terminal after the passenger places the order.

In some exemplary implementations of the embodiment, if the ride-hailing service center receives the ride-hailing operation information transmitted by the mobile terminal of the ride-hailing agent:

transmitting a distribution request to the mobile terminal of the passenger, wherein the distribution request is about whether the ride-hailing service center is permitted to distribute the collected image inside and/or outside the vehicle to the mobile terminal of the ride-hailing agent.

By adopting the implementation, if the ride-hailing agent carries out the ride-hailing operation, the passenger can select whether the mobile terminal of the ride-hailing agent is used as the receiving terminal for the image distribution. It is noted that, if the ride-hailing agent carries out the ride-hailing operation, the preset condition may be set by the ride-hailing agent, or the preset condition may be set still by the passenger through the mobile terminal of the passenger.

In some exemplary implementations of the embodiment, if the triggering condition is the sensing of the passenger entering the vehicle, the method further comprises:

informing the passenger whether the service request is permitted to be transmitted to the ride-hailing service center. For example, the passenger may be notified via the mobile terminal of the passenger, or the passenger may be notified via a device such as a display screen, a speaker, or the like included in the vehicle terminal.

In some exemplary implementations of the embodiment, the obtaining of the image inside and/or outside the vehicle collected by the vehicle terminal further comprises: obtaining an image of a key frame outside the vehicle collected by the vehicle terminal, wherein the key frame is an image frame containing a landmark building during a trip. That is, only the image of the key frame outside the vehicle is collected when the image outside the vehicle is collected.

By adopting the implementation, the data transmission quantity of an image uploaded to the ride-hailing service center can be saved, thereby ensuring the image is uploaded in time. The landmark building can be obtained by carrying out map indexing on the preset route in advance through the ride-hailing service center. Moreover, the image outside the vehicle can be uploaded at a preset time interval or a time when to upload the image can be controlled by the passenger through a service request.

In some exemplary implementations of the embodiment, the method further comprises:

obtaining, by the ride-hailing service center, according to a service request, a sound inside and/or outside the vehicle collected by the vehicle terminal, and distributing the sound inside and/or outside the vehicle.

By adopting the implementation, the image and the sound inside and/or outside the vehicle are used as the records of the monitoring, so that an integrity of the records of the monitoring can be improved. The sound inside and/or outside the vehicle may be distributed in a manner similar to the distributing of the image according to a preset condition.

Moreover, in order to further improve the integrity of the records of the monitoring and to be more beneficial for the monitoring, the method further comprises: obtaining, by the ride-hailing service center, according to the service request, position information obtained by positioning the vehicle through the vehicle terminal, and distributing the position information. That is, the image, the sound and the position information inside and/or outside the vehicle are used as the records of the monitoring. The position information may also be distributed in a manner similar to the distributing of the image according to the preset condition. The positioning can adopt one or more of positioning manners such as GPS positioning, Beidou positioning, 4G/5G positioning and the like. For example, at least a GPS/Beidou dual-mode positioning manner is adopted, so that the positioning can also be realized in an environment where a mobile communication network is unstable.

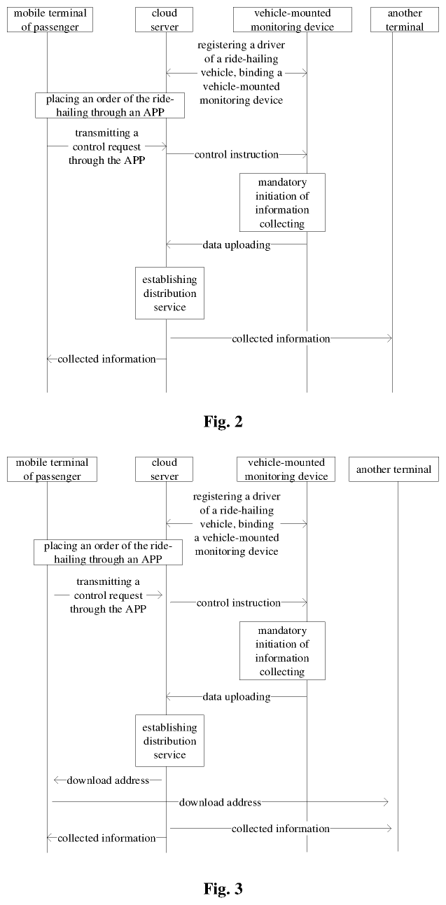

As shown in FIG. 2, a specific process of the method for monitoring the ride-hailing vehicle provided by the embodiment is as follows: the passenger performs the ride-hailing through an APP or a webpage client of the mobile terminal, and the ride-hailing service center associates the mobile terminal of the passenger with a vehicle terminal of the ride-hailing vehicle; the ride-hailing center, after receiving the service request, obtains the image inside and/or outside the vehicle collected by the vehicle terminal; the ride-hailing service center distributes the obtained image information and transmits it to the mobile terminal of the passenger and another receiving terminal (such as the mobile terminal of the family member of the passenger) specified in the service request.

As shown in FIG. 3, another specific flow of the method for monitoring the ride-hailing vehicle provided by the embodiment is as follows: the passenger performs the ride-hailing through an APP or a webpage client of the mobile terminal, and the ride-hailing service center associates the mobile terminal of the passenger with the vehicle terminal; the ride-hailing service center, after receiving the service request, obtains the image inside and/or outside the vehicle collected by the vehicle terminal; the ride-hailing service center stores the image locally and transmits a service address to the mobile terminal of the passenger, the mobile terminal of the passenger transmits the service address to another terminal (such as the mobile terminal of the family member of the passenger), and the mobile terminal of the passenger and the other receiving terminal can access, according to the service address, the server of the ride-hailing service center to download the collected information.

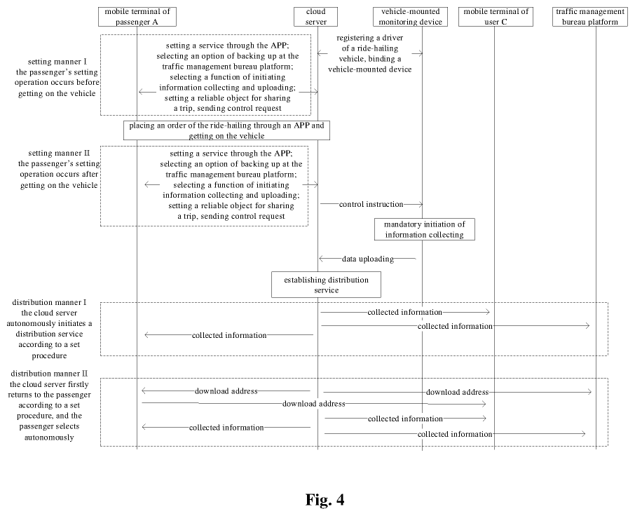

As shown in FIG. 4, another specific flow of the method for monitoring the ride-hailing vehicle provided by the embodiment is as follows: a passenger A performs the ride-hailing through an APP or a webpage client of the mobile terminal, and the ride-hailing service center associates the mobile terminal of the passenger A with the vehicle terminal; the passenger A transmits a service request to the ride-hailing service center before or after getting on the vehicle; the ride-hailing service center, after receiving the service request, obtains the image inside and/or outside the vehicle collected by the vehicle terminal; and the ride-hailing service center transmits the obtained image information to the mobile terminals of the passenger A and a user C as well as the traffic management bureau platform; alternatively, the ride-hailing service center locally stores the image information and transmits a service address to the mobile terminal of the passenger A, and the mobile terminal of the passenger A transmits the service address to the mobile terminal of the user C and the traffic management bureau platform.

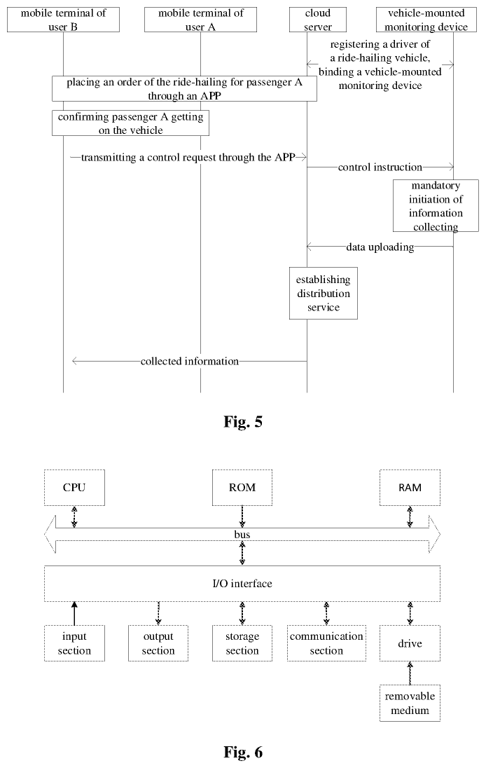

As shown in FIG. 5, another specific flow of the method for monitoring the ride-hailing vehicle provided by the embodiment is as follows: a user B performs the ride-hailing for the passenger A through an APP or a webpage client of the mobile terminal and transmits a distribution request to the mobile terminal of the passenger A, the passenger A permits the mobile terminal of the user B to be used as a receiving terminal, and the ride-hailing service center associates the mobile terminal of the passenger A with the vehicle terminal; the passenger A transmits a service request to the ride-hailing service center before or after getting on the vehicle; the ride-hailing service center, after receiving the service request, obtains the image inside and/or outside the vehicle collected by the vehicle terminal; and the ride-hailing service center transmits the obtained image information to the mobile terminal of the user B.

Another embodiment of the disclosure provides a system for monitoring a ride-hailing vehicle, comprising: a device for monitoring the ride-hailing vehicle, a vehicle terminal and a ride-hailing service center;

wherein the device for monitoring the ride-hailing vehicle is configured to transmit a service request to the ride-hailing service center in response to a triggering condition;

wherein the ride-hailing service center is configured to obtain, according to the service request, an image inside and/or outside the vehicle collected by the vehicle terminal, and distribute the image inside and/or outside the vehicle.

According to the system for monitoring the ride-hailing vehicle provided by the embodiment, the ride-hailing service center obtains, according to a service request, the image inside and/or outside the vehicle collected by the vehicle terminal, and distributes them, so that it is possible to implement that the monitoring of the ride-hailing vehicle can be initiated by the passenger through the ride-hailing service center or the monitoring of the ride-hailing vehicle can be automatically initiated according to a preset triggering condition, which is beneficial for the monitoring of the ride-hailing vehicle by the ride-hailing service center, increases the safety factor of the passenger when taking the ride-hailing vehicle, and the uploaded information (i.e., the records of the monitoring) can be used as evidences after the event such as conflict, personal injury or the like occurs.

For example, the device for monitoring the ride-hailing vehicle and the vehicle terminal can be independently arranged, or can also be implemented by being integrated in a dashboard camera or modifying the existing dashboard camera. Referring to FIG. 1B, the device for monitoring the ride-hailing vehicle comprises a processor 202 configured to transmit a service request to the ride-hailing service center in response to a triggering condition, wherein the processor 202 may be arranged at the mobile terminal of the passenger or may be arranged separately on the vehicle. For example, the processor 202 may comprise one or more of a digital processor, an analog processor, a digital circuit designed to process information, an analog circuit designed to process information, a state machine, and/or other mechanisms for electronically processing information. The vehicle terminal comprises a microphone, a camera, and the like. A plurality of cameras may be arranged at different positions so that the image inside and outside the vehicle can be collected from a plurality of viewing angles.

Referring to FIG. 1B, in some exemplary implementations of the embodiment, the device for monitoring the ride-hailing vehicle further comprises:

a vehicle-mounted trigger switch 204 and/or a trigger 206 arranged in the mobile terminal of the passenger, which are respectively configured to receive the triggering action of the passenger. For example, the vehicle-mounted trigger switch 204 may comprise one or more of a button switch, a key switch, a two-piece trigger switch, a single piece trigger switch, a resistive or conductive film pressure sensitive switch, and/or a capacitive finger touch switch. As another example, the trigger 206 may comprise one or more of a button trigger, a key trigger, a two-piece trigger, a single piece trigger, a resistive or conductive film pressure sensitive trigger, and/or a capacitive finger touch trigger.

By adopting the implementation, it is possible to implement that the transmitting of the service request can be triggered by the passenger through the triggering action via the mobile terminal or the vehicle-mounted service request button, and it is possible to implement that the monitoring of the ride-hailing vehicle can be initiated by the passenger through the ride-hailing service center. It will be appreciated that if the vehicle-mounted trigger switch 204 is only included, the processor 202 may be arranged independently within the vehicle; if the trigger 206 arranged in the mobile terminal of the passenger is only included, the processor 202 may be arranged at the mobile terminal of the passenger; if the vehicle-mounted trigger switch 204 and the trigger 206 arranged in the mobile terminal of the passenger are included, the processor 202 may be arranged at the mobile terminal of the passenger and independently within the vehicle, respectively.

Referring to FIG. 1B, in some exemplary implementations of the embodiment, the processor 202 may be further configured to:

acquire a current position of the vehicle;

determine whether the current position deviates from a preset route, and if so, instruct to transmit a service request.

By adopting the implementation, it is possible to implement, by determining whether the current position deviates from the preset route, that the monitoring of the ride-hailing vehicle can be automatically initiated by the ride-hailing service center. It can be understood that the current position of the vehicle can be obtained by using one or more of the positioning manners such as a GPS positioning chip, a Beidou positioning chip, and 4G/5G positioning. For example, the current position of the vehicle can be obtained by using a vehicle-mounted GPS/Beidou positioning chip, so that the current position of the vehicle can also be obtained in an environment where a mobile communication network is unstable. Moreover, the current position information can also be uploaded to the ride-hailing service center.

Referring to FIG. 1B, in some exemplary implementations of the embodiment, the device for monitoring the ride-hailing vehicle further comprises:

a pressure sensor 212 configured to sense whether the passenger sits within the vehicle. For example, the pressure sensor 212 may comprise one or more of a piezoresistive pressure sensor, a ceramic pressure sensor, a diffused silicon pressure sensor, a sapphire pressure sensor, and/or a piezoelectric pressure sensor.

The processor 202 is further configured to instruct to transmit a service request if the pressure sensor 212 senses that the passenger sits within the vehicle.

By adopting the implementation, it is possible to implement, by sensing the triggering condition of the passenger entering into the vehicle, that the monitoring of the ride-hailing vehicle can be automatically initiated by the ride-hailing service center.

As shown in FIG. 6, a computer system suitable for implementing a server of the ride-hailing service center comprises a Central Processing Unit (CPU) that can perform various appropriate actions and processes according to a program stored in a Read Only Memory (ROM) or a program loaded from a storage section into a Random Access Memory (RAM). In the RAM, various programs and data necessary for the operation of the computer system are also stored. The CPU, the ROM and the RAM are connected to each other via a bus. An input/output (I/O) interface is also connected to the bus.

The following parts are connected to the I/O interface: an input section including a keyboard, a mouse, and the like; an output section including a display such as a Liquid Crystal Display (LCD) and a speaker; a storage section such as a hard disk; and a communication section including a network interface card such as a LAN card, a modem, or the like. The communication section performs communication processing via a network such as Internet. A drive is also connected to the I/O interface as needed. A removable medium such as a magnetic disk, an optical disk, a magneto-optical disk, a semiconductor memory, or the like is mounted on the drive as needed, so that the computer program read out therefrom is installed into the storage section as needed.

In particular, the processes described by the above flowcharts may be implemented as computer software programs according to the embodiment. For example, the embodiment comprises a computer program product comprising a computer program tangibly embodied on a computer-readable medium, the computer program comprising a program code for performing the method illustrated in the flow chart. In such an embodiment, the computer program may be downloaded and installed from a network via the communication section, and/or installed from a removable medium.

The flowchart and schematic diagrams in the figures illustrate the architecture, functionality, and operation of possible implementations of the system, the method and the computer program product according to the embodiment. In this regard, each block in the flowchart or schematic diagrams may represent a module, a segment, or a portion of the code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or they may sometimes be executed in the reverse order, depending upon the functionality involved. It will also be noted that each block of the schematic and/or flowchart illustration, and combinations of blocks in the schematic and/or flowchart illustration, can be implemented by special purpose hardware-based systems which perform the specified functions or acts, or combinations of special purpose hardware and computer instructions.

On the other hand, the embodiment also provides a nonvolatile computer storage medium, which may be the nonvolatile computer storage medium included in the apparatus in the above embodiment, or may be a nonvolatile computer storage medium that exists separately and is not assembled in a terminal. The nonvolatile computer storage medium stores one or more programs that, when executed by a device, cause the device to: obtain, according to a service request transmitted to a ride-hailing service center in response to a trigger condition, an image inside and/or outside the vehicle collected by a vehicle terminal, and distribute the image inside and/or outside the vehicle.

It should be understood that the above-described embodiments of the disclosure are merely examples for clearly illustrating the disclosure and are not intended to limit the embodiments of the disclosure, and that those skilled in the art, on the basis of the above description, may make other variations or modifications, which are not exhaustive of all embodiments, and obvious variations or modifications of the embodiments disclosed are within the scope of the disclosure.

1. A method for monitoring a ride-hailing vehicle, comprising:
transmitting a service request to a ride-hailing service center in response to a triggering condition, so that the ride-hailing service center obtains an image inside and/or outside a vehicle collected by a vehicle terminal, and distributes the image inside and/or outside the vehicle.

2. The method of claim 1, wherein the triggering condition comprises at least one of:
sensing a triggering action from a passenger;
sensing that a current position deviates from a preset route; and
sensing the passenger entering into the vehicle.

3. The method of claim 2, wherein if the triggering condition is the sensing of the passenger entering into the vehicle, the method further comprises:
informing the passenger whether the service request is permitted to be transmitted to the ride-hailing service center.

4. The method of claim 1, wherein the obtaining of the image inside and/or outside the vehicle collected by the vehicle terminal further comprises: obtaining an image of a key frame outside the vehicle collected by the vehicle terminal, wherein the key frame is an image frame containing a landmark buildings during a trip.

5. The method of claim 1, further comprising: transmitting the service request to the ride-hailing service center in response to the triggering condition, so that the ride-hailing vehicle service center obtains a sound inside and/or outside the vehicle collected by the vehicle terminal, and distributes the sound inside and/or outside the vehicle.

6. The method of claim 1, further comprising: transmitting the service request to the ride-hailing service center in response to the triggering condition, so that the ride-hailing service center obtains position information obtained by positioning the vehicle through the vehicle terminal, and distributes the position information.

7. A method for monitoring a ride-hailing vehicle, comprising:
obtaining, by a ride-hailing service center, according to a service request, an image inside and/or outside a vehicle collected by a vehicle terminal, and distributing the image inside and/or outside the vehicle, wherein the service request is transmitted to the ride-hailing service center in response to a triggering condition.

8. The method of claim 7, wherein the distributing of the image inside and/or outside the vehicle further comprises:
distributing the image inside and/or outside the vehicle according to a preset condition, wherein the preset condition comprise at least one of:
distributing the image to a mobile terminal of a passenger;
distributing the image to a third-party receiving terminal; and
storing the image locally at the ride-hailing service center, and distributing a service address to a client of the passenger or the third-party receiving terminal.

9. The method of claim 8, wherein the preset condition is set by the mobile terminal of the passenger.

10. The method of claim 7, further comprising: obtaining, by the ride-hailing service center, according to the service request, a sound inside and/or outside the vehicle collected by the vehicle terminal, and distributing the sound inside and/or outside the vehicle.

11. The method of claim 7, further comprising: obtaining, by the ride-hailing service center, according to the service request, position information obtained by positioning the vehicle through the vehicle terminal, and distributing the position information.

12. The method of claim 7, further comprising:
receiving, by the ride-hailing service center, ride-hailing operation information transmitted by the mobile terminal of the passenger or a ride-hailing agent.

13. The method of claim 12, wherein if the ride-hailing service center receives the ride-hailing operation information transmitted by the mobile terminal of the ride-hailing agent:
transmitting a distribution request to the mobile terminal of the passenger, wherein the distribution request is about whether the ride-hailing service center is permitted to distribute the image inside and/or outside the vehicle to the mobile terminal of the ride-hailing agent.

14. A device for monitoring a ride-hailing vehicle, comprising:
a processor configured to perform the method for monitoring a ride-hailing vehicle according to claim 1.

15. The device of claim 14, further comprising:
a vehicle-mounted trigger switch and/or a trigger arranged in a mobile terminal of a passenger, which are respectively configured to receive a triggering action of the passenger.

16. The device of claim 14, wherein the processor is further configured to:
obtain a current position of the vehicle; and
determine whether the current position deviates from a preset route, and if so, instruct to transmit the service request.

17. The device of claim 14, further comprising:
a pressure sensor configured to sense whether a passenger sits within the vehicle;
wherein the processor is further configured to: instruct to transmit the service request if the pressure sensor senses that the passenger sits within the vehicle.

18. A system for monitoring a ride-hailing vehicle, comprising: a device for monitoring the ride-hailing vehicle, a vehicle terminal and a ride-hailing service center;
wherein the device for monitoring the ride-hailing vehicle is configured to transmit a service request to the ride-hailing service center in response to a triggering condition; and
wherein the ride-hailing service center is configured to obtain, according to the service request, an image inside and/or outside a vehicle collected by the vehicle terminal, and distribute the image inside and/or outside the vehicle.
